(19) United States
(12) Patent Application Publication
(10) Pub. No.: US 2018/0268085 A1
(43) Pub. Date: Sep. 20, 2018

(54) TURBULENCE-GENERATING GRID AND METHOD OF DESIGN AND MANUFACTURE THEREFOR

(71) Applicant: IMPERIAL INNOVATIONS LTD, London (GB)

(72) Inventors: John Christos VASSILICOS, London (GB); Paul John Kenneth BRUCE, London (GB); Shaokai ZHENG, London (GB); John Michael Russell GRAHAM, London (GB)

(21) Appl. No.: 15/983,393

(22) Filed: May 18, 2018

Related U.S. Application Data
(63) Continuation of application No. PCT/EP2016/078209, filed on Nov. 18, 2016.

(30) Foreign Application Priority Data
Nov. 20, 2015 (GB) 1520479.5

(51) Int. Cl. G06F 17/50; F15D 1/02

(52) U.S. Cl. CPC G06F 17/50; G06F 2217/12; G06F 2217/16; F15D 1/025

(57) ABSTRACT

A turbulence-generating grid for producing a turbulent flow is provided. The grid has a top and a bottom and opposed sides and comprises a number N of layers, each layer being defined between respective pairs of horizontal bars and the sides of the grid. Each layer is subdivided by a number cₙ of vertical bars so as to define a plurality of respective through holes between at least adjacent pairs of the vertical bars and the horizontal bars. At least one of the dimensions and the spacings of the vertical bars of one of the layers is different from the at least one of the dimensions and the spacings of the vertical bars of another of the layers.

### CROSS-REFERENCE TO RELATED APPLICATIONS

This application is a continuation under 35 U.S.C. § 120 of International Application No. PCT/EP2016/078209, filed Nov. 18, 2016, which claims priority to United Kingdom Application No. GB 1520479.5, filed Nov. 20, 2015 under 35 U.S.C. § 119(a). Each of the above-referenced patent applications is incorporated by reference in its entirety.

### BACKGROUND OF THE INVENTION

### Technical Field

The present invention relates to a turbulence-generating grid and a method of manufacturing a turbulence-generating grid.

### Background

Turbulence-generating barriers or meshes or grids or the like are often used in wind tunnels and the like to produce turbulent boundary layer flows that correspond to or mimic actual flow over a real structure. For example, in civil engineering experiments to test large scale structures, e.g. skyscrapers and other large buildings and long span bridges, etc., it is important to reproduce the corresponding turbulent boundary layer flows over a model of the proposed structure in a wind tunnel. Many such turbulence-generating barriers or meshes or grids or the like are known. Typically, however, the design and production of such generating barriers or meshes or grids or the like is effectively done on a trial-and-error basis, with a first prototype being built and used in an initial experiment, and the prototype then being modified manually to try to adjust the properties of the flow that is produced in order to meet design requirements. This is a slow and laborious process, which relies heavily on personal experience and expertise of the individuals designing the grid or the like to manually adjust the prototypes, who will often have to work by “feel” in modifying the design of the prototypes.

### SUMMARY

According to a first aspect of the present invention, there is provided a turbulence-generating grid for producing a turbulent flow, the grid having a top and a bottom and opposed sides and comprising a number N of layers, each layer being defined between respective pairs of horizontal bars and the sides of the grid, each layer being subdivided by a number cₙ of vertical bars so as to define a plurality of respective through holes between at least adjacent pairs of the vertical bars and the horizontal bars,
wherein at least one of the dimensions and the spacings of the vertical bars of one of the layers is different from the at least one of the dimensions and the spacings of the vertical bars of another of the layers.

In an embodiment, the aspect ratios of each of the vertical bars across a layer are the same.

In an embodiment, each layer has a respective blockage ratio σₙ, and the blockage ratio σₙ for at least some of the layers are different from each other.

In an embodiment, the difference of the blockage ratio between two adjacent layers is the same for all pairs of adjacent layers of the grid.

In an embodiment, the dimensions and the spacings of the vertical bars of one of the layers are different from the dimensions and the spacings of the vertical bars of another of the layers.

In an embodiment, at least one of the dimensions and the spacings of the vertical bars of each of the layers differ from layer to layer.

In an embodiment, at least one of the dimensions and the spacings of the vertical bars of the layers changes monotonically from layer to layer.

According to a second aspect of the present invention, there is provided a method of manufacturing a turbulence-generating grid which in use produces a turbulent flow having a mean velocity profile and a turbulence intensity profile, the grid having a top and a bottom and opposed sides and comprising a number N of layers, wherein n is the layer number for the respective layers, each layer being defined between respective pairs of horizontal bars and the sides of the grid, each layer being subdivided by a number cₙ of vertical bars so as to define a plurality of respective through holes between at least adjacent pairs of the vertical bars and the horizontal bars, each layer having a respective blockage ratio σₙ, the method comprising:
selecting the number N of layers;
calculating the height hₙ of each of the layers;
calculating a blockage ratio σₙ of each of the layers to achieve the desired mean velocity profile;
calculating the number cₙ of vertical bars and the dimensions and spacings of the vertical bars for each of the layers to achieve the calculated blockage ratio σₙ of each of the layers and the desired turbulence intensity profile of the grid; and
manufacturing the turbulence-generating grid having the selected number N of layers, calculated height hₙ of each of the layers, and calculated number cₙ of vertical bars and calculated dimensions and spacings of the vertical bars for each of the layers.

Embodiments of this aspect of the present invention provide a method of manufacturing a turbulence-generating grid which enables desired flow characteristics to be achieved in a straightforward and systematic manner. In practice, little or no modification of the initially-produced turbulence-generating grid is required to obtain the desired flow characteristics.

In an embodiment, the aspect ratio of the vertical bars within at least one of the layers are the same for all vertical bars across said layer.

In an embodiment, the number cₙ of vertical bars and the dimensions and spacings of the vertical bars for each of the layers is calculated so as to maintain constant the aspect ratio of each of the vertical bars across a layer.

In an embodiment, the method comprises attaching blocks of varying thicknesses to the grid in order to maintain the constant aspect ratio of each of the vertical bars across a layer.

In an embodiment, for each of the layers, the width wₙ of the vertical bars of the layer is calculated according to:

$${w}_{n} = \{ \begin{matrix}( ( W * {h}_{n} * {σ}_{n} - W * t ) / ( {h}_{n} - t ) ) / {c}_{n} & n = 2 , 3 , … N - 1 \\ ( ( W * {h}_{n} * {σ}_{n} - W * 0.5 t ) / ( {h}_{n} - 0.5 t ) ) / {c}_{n} & n = 1 , N\end{matrix} .$$

wherein:
W is the overall width of the grid
hₙ is the height of the layer
σₙ is the blockage ratio of the layer
t is the width of the horizontal bars of the layer
cₙ is the number of vertical bars of the layer.

In an embodiment, the difference of the blockage ratio between two adjacent layers is the same for all pairs of adjacent layers of the grid.

In an embodiment, the dimensions and the spacings of the vertical bars of one of the layers are different from the dimensions and the spacings of the vertical bars of another of the layers.

In an embodiment, at least one of the dimensions and the spacings of the vertical bars of each of the layers differ from layer to layer.

In an embodiment, at least one of the dimensions and the spacings of the vertical bars of the layers changes monotonically from layer to layer.

There may be provided a turbulence-generating grid manufactured in accordance with a method as described above.

According to a third aspect of the invention there is provided a computer-implemented method of designing a turbulence-generating grid which in use produces a turbulent flow having a mean velocity profile and a turbulence intensity profile, the grid having a top and a bottom and opposed sides and comprising a number N of layers, wherein n is the layer number for the respective layers, each layer being defined between respective pairs of horizontal bars and the sides of the grid, each layer being subdivided by a number cₙ of vertical bars so as to define a plurality of respective through holes between at least adjacent pairs of the vertical bars and the horizontal bars, each layer having a respective blockage ratio σₙ, the method comprising:
selecting the number N of layers;
calculating the height hₙ of each of the layers;
calculating a blockage ratio σₙ of each of the layers to achieve the desired mean velocity profile; and
calculating the number cₙ of vertical bars and the dimensions and spacings of the vertical bars for each of the layers to achieve the calculated blockage ratio σₙ of each of the layers and the desired turbulence intensity profile of the grid.

Further features and advantages of the invention will become apparent from the following description of preferred embodiments of the invention, given by way of example only, which is made with reference to the accompanying drawings.

### BRIEF DESCRIPTION OF THE DRAWINGS

FIGS. 1a to 1c show schematically front or face-on elevations of three examples of turbulence-generating grids;

FIG. 2 shows profiles of (1−σ)/(1−σ_{c}) for the grids of FIGS. 1a to 1c respectively, where σ_{c} is the blockage ratio at layer 5, the center of the grid;

FIG. 3a shows vertical drag coefficient profiles of grids with uniform thickness D=10 mm;

FIG. 3b shows vertical drag coefficient profiles of grids with variable thickness but uniform aspect ratio;

FIGS. 4a to 4c show vertical profiles of the normalized streamwise velocity U/U_{c} (symbols) and predictions (dashed lines) for grids with modified thicknesses;

FIG. 5 shows turbulence intensity profiles along the centerline of prior art “fractal” grids;

FIGS. 6a to 6c show the scaling of the normalized turbulence intensity of the grids shown in FIGS. 1a, 1b and 1c respectively;

FIG. 7 shows the longitudinal integral length scale L profiles versus the streamwise location x for the grids of FIGS. 1a, 1b and 1c respectively.

### DETAILED DESCRIPTION OF CERTAIN INVENTIVE EMBODIMENTS

In examples of embodiments of the present invention, a number of parameters are effectively input to the design process so as to produce a turbulence-generating grid which provides desired flow characteristics in use. The design process enables grids to be manufactured that generate shear flows with different desired gradients and enables flow quantities like turbulence level and length scale to be obtained as desired. In some examples, the blockage ratio of each layer of the grid is varied according to design requirements for the shear flow gradient, which may be linear or non-linear and which is controlled in some examples by the height of each layer. While maintaining the blockage ratio of each layer, the width and gap distance of the vertical bars can be varied as well, producing different turbulence and integral length scales in the flow. In order to have further control over the turbulence intensity, the thickness of the vertical bars can be easily changed to alter the drag coefficient. This third dimension of the grid provides further tuning capabilities of the flow. In general, it has been found that slight changes to the design parameters enable very different turbulent flows to be obtained in a wind tunnel, providing for enormous flexibility in the flow characteristics to be obtained in use.

The turbulence-generating grid may be made of for example acrylic or some other plastics, though other materials such as wood, metal, etc. may be used. It is convenient to manufacture the turbulence-generating grid by for example laser cutting or water jet cutting depending on the material, though other techniques may be used, including moulding for example.

The steps relating to the design of the grid described herein may be computer-implemented or computer-assisted. For example, software written in a computing language such as MATLAB may be used together with user-input parameters to facilitate the design process.

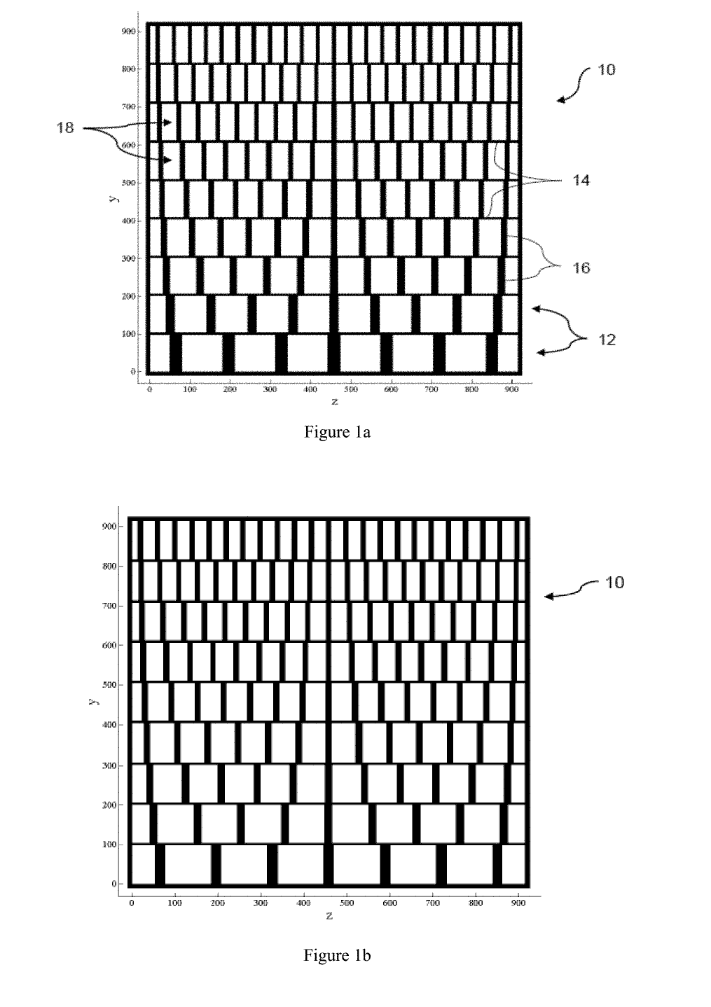

FIGS. 1a to 1c show schematically front or face-on elevations of three examples of turbulence-generating grids 10. The details of the grids 10 will be discussed further below. Briefly, each grid 10 has a number of horizontal layers 12, which are formed or defined by a number of horizontal bars or rods 14 and a number of vertical bars or rods 16 which define spaces 18 there between and between which fluid, typically air, flows in use. (It will be understood that the terms “horizontal” and “vertical” are used here for convenience and brevity, and reflect the usual orientation for the grids 10 when in use, but that the grids 10 may be rotated in use in some circumstances so that the bars 14, 16 may be angled to the horizontal and vertical in use in some cases.) The cross-sectional shapes of the horizontal and vertical bars 14, 16 may be the same as or different from each other, and may in general be for example square, rectangular, triangular or other polygonal shape, elliptical, circular, etc.

Table 1 below sets out a number of parameters relevant for present purposes.

TABLE 1

| | |
|---|---|
| External height and width of grid | H, W |
| Thickness of the grid (streamwise direction) | D |
| Number of layers | N |
| Height of each layer | hₙ |
| Blockage ratio of each layer | σₙ |
| Number of vertical bars at each layer | cₙ |
| Width of the vertical bar (transverse direction) | wₙ |
| Distance between two adjacent vertical bars at the same | gₙ |
| layer | |
| Aspect ratio of the vertical bars | aₙ |
| Thickness of the vertical bar (streamwise direction) | dₙ |
| Width of horizontal bars (vertical direction) | t |

The first parameters are the external dimensions H and W of the grid 10. In practice, these will often be the same as or close to the cross-sectional dimensions of the wind tunnel's test section (where by convention the flow is in the x-direction along the tunnel, y is along the height of the wind tunnel and z is across the width of the wind tunnel). In these particular examples which have been subject to testing, H=W=3 feet (approximately 90 cm), corresponding to the cross-sectional dimensions of the wind tunnel in which the testing took place.

The next parameter to consider is the number N of horizontal layers 12 of the grid 10. In the examples shown in FIGS. 1a to 1c, N=9 in each case. For a higher or lower resolution of the flow profiles (along y), a higher or lower value of N can be chosen respectively. By “higher resolution” it is meant that when for example approximating a circle using a polygon, a larger number of points for the polygon is used, and, correspondingly, for a “lower resolution” a smaller number of points is used. For example, a higher resolution may be useful when fast changes in flow quantities along y are required. In this specification, the suffix n is used to indicate the individual horizontal layers 12.

The height of each layer 12 (in the y direction) is hₙ. The height of each layer 12 is set so that the grid 10 has an overall desired height, which will typically be the same as or close to height of the wind tunnel's test section. In general, the heights of the layers 12 may all be the same, or may all be different, or some may be the same and one or more may be different. In the case of the specific examples of actual grids 10 which have been subject to experiment, the height of each layer 12 was the same, and was h=101.67 mm.

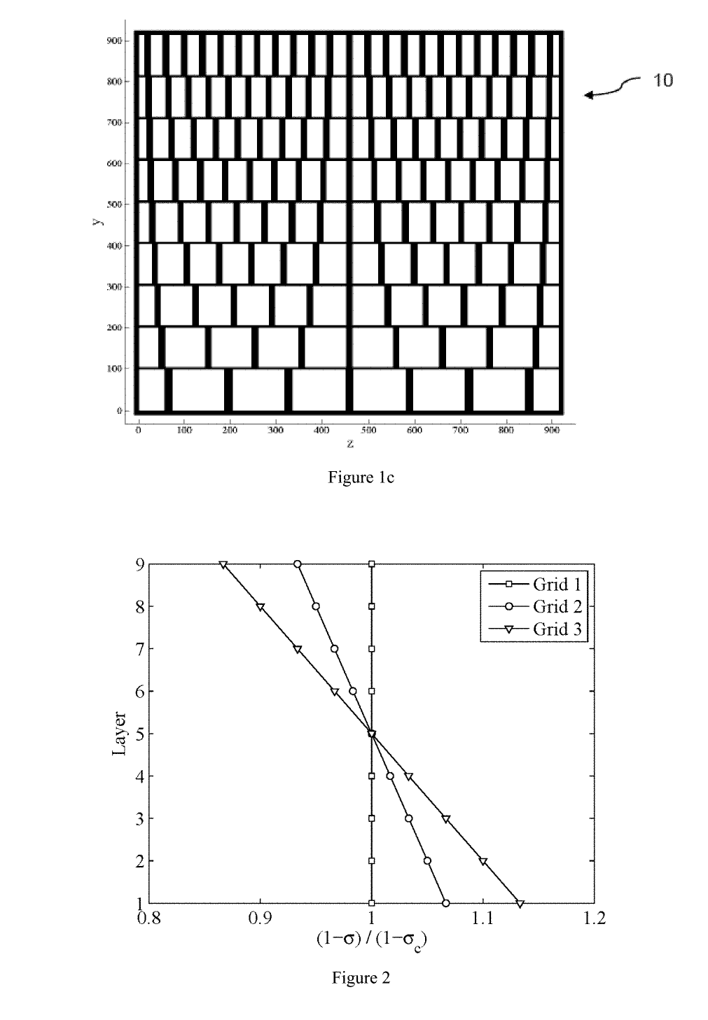

An important parameter in order to obtain a desired mean flow profile produced by a turbulence-generating grid 10 is the blockage ratios for each layer 12. (In general, the blockage ratio is the ratio of the frontal area of the blockage to the cross-sectional area of the wind tunnel in which the blockage is present. In this case, the blockage ratio of a layer 1 is the ratio of the total frontal area of the horizontal and vertical bars 14, 16 of the layer 12 to the total cross-sectional area of the layer 12.) There are therefore a number N of blockage ratios. Together they form a blockage ratio profile, that is, a profile of blockage ratios across the grid 10. The blockage ratio profiles for each of the grids 10 shown by way of example in FIG. 1 are shown in FIG. 2, where squares are for the grid 1 of FIG. 1a, circles are for the grid 2 of FIG. 1b, and diamonds are for the grid 3 of FIG. 1c. For these particular examples of grids 10, the differences of the blockage ratio from one layer 12 to an adjacent layer 12 are chosen to be 0%, 10%, and 20% respectively, with a mean blockage across all layers 12 being 25%. In these examples, the difference of the blockage ratio between two adjacent layers 12 is the same for all pairs of adjacent layers 12, but this does not need to be so in general. As will be discussed further below, the blockage ratio profile is a good predictor of the designed mean flow profile. In particular, a desired mean velocity flow can be achieved by providing a particular blockage ratio profile.

The next step is to determine the dimensions and spacings of the vertical bars 16 in each horizontal layer 12 in a way which achieves the blockage ratio of that layer 12 and at the same time allows the desired turbulence intensity and integral length scale profiles to be obtained. The turbulence intensity, also often referred to as turbulence level, is defined as I=u′/U where u′ is the root-mean-square of the turbulent velocity fluctuations at a particular location over a specified period of time and U is the mean velocity at the same location over the same time period.

While the blockage profile controls the mean velocity profile of the flow produced by the grid 10, the vertical bars 16 are intended principally to control and vary the wake interaction mechanisms in order to control the turbulence characteristics of the flow. Four parameters are introduced here, namely cₙ the number of the vertical bars 16 in a layer 12, gₙ the gap or spacing between two adjacent bars 16 in a layer 12, wₙ the transverse or lateral width of each individual bar 16, and aₙ the aspect ratio of the bars 16, which is defined as the ratio of depth or chord dₙ over width wₙ. In one example, the number of the bars 16 is set for each layer to be cₙ=2n+5 for n=1 to N in the examples shown in FIG. 1. Since the horizontal bars 14 are in practice intended principally for manufacturing purposes only, to provide structure and strength to the grid 10, their width t (measured in the vertical direction y) is chosen according to the overall blockage required in relation to the overall mean flow that is desired. For the examples shown in FIG. 1, the width t of each horizontal bar 14 is 5 mm. In some cases, it might be desirable to minimise the effect of the wakes of the horizontal bars 14, which is achieved in the grids of FIG. 1 by setting D/t=2.

In an example, to calculate the width wₙ of the vertical bars 16, the following equations may be used:

$${w}_{n} = \{ \begin{matrix}( ( W * {h}_{n} * {σ}_{n} - W * t ) / ( {h}_{n} - t ) ) / {c}_{n} & n = 2 , 3 , … N - 1 \\ ( ( W * {h}_{n} * {σ}_{n} - W * 0.5 t ) / ( {h}_{n} - 0.5 t ) ) / {c}_{n} & n = 1 , N\end{matrix} .$$

The purpose behind the second equation for wₙ is to remove the effect of the thickness of the horizontal bars 14 on the wall of the wind tunnel at the top and bottom of the grid 10, so as not to trip the boundary layer on the wall of the wind tunnel and cause unwanted interactions with the turbulent flow from the grid 10. In the examples shown in FIG. 1, the vertical bars 16 within each layer 12 are evenly separated by the same spacing gₙ in order not to create inhomogeneities in the z direction (across the width of the wind tunnel). However, in some cases such inhomogeneities are desired in which case the gap gₙ between vertical bars 16 can be variable within each layer 12 or at least within some layers 12. The separation distance gₙ determines the integral scale corresponding to the layer number n and together these separation distances determine the integral scale profile.

By way of illustrative example, the dimensions of the vertical bars 16 and the corresponding blockage ratio σₙfor each layer 12 of the grids 10 shown in FIG. 1 are given in Table 2 below.

TABLE 2

| | Grid 1 | | | Grid 2 | | | Grid 3 | | |
|---|---|---|---|---|---|---|---|---|---|
| | wₙ | gₙ | | w | gₙ | | wₙ | gₙ | |
| n | (mm) | (mm) | σₙ (%) | (mm) | (mm) | σₙ (%) | (mm) | (mm) | σₙ (%) |
| 9 | 9.1935 | 39.78 | 24.9915 | 11.23 | 39.78 | 29.9933 | 13.27 | 39.78 | 34.9951 |
| 8 | 9.2026 | 43.57 | 24.9944 | 10.92 | 43.57 | 28.7478 | 12.64 | 43.57 | 32.5012 |
| 7 | 10.1713 | 48.16 | 24.9975 | 11.44 | 48.16 | 27.5049 | 12.70 | 48.16 | 29.9927 |
| 6 | 11.3679 | 53.82 | 25.0037 | 12.08 | 53.82 | 26.2580 | 12.78 | 53.82 | 27.4945 |
| 5 | 12.8836 | 61.00 | 24.9944 | 12.88 | 61.00 | 24.9944 | 12.88 | 61.00 | 24.9944 |
| 4 | 14.8657 | 70.38 | 25.0058 | 13.94 | 70.38 | 23.7495 | 13.02 | 70.38 | 22.5066 |
| 3 | 17.5686 | 83.18 | 25.0016 | 15.38 | 83.18 | 22.4983 | 13.19 | 83.18 | 19.9950 |
| 2 | 21.4727 | 101.67 | 24.9975 | 17.46 | 101.67 | 21.2472 | 13.45 | 101.67 | 17.4969 |
| 1 | 30.2071 | 130.71 | 25.0022 | 23.51 | 130.71 | 20.0025 | 16.81 | 130.71 | 15.0029 |

(For completeness, it is mentioned that the values of blockage ratio σₙ shown in Table 2 are obtained using the calculated values of wₙ and gₙ which yields discrepancies between design values of the blockage ratio σₙ due to round off errors arising from keeping just two decimal digits of w and g for manufacturing purposes. However, the differences between the obtained values and the desired values for the blockage ratio σₙ are usually smaller than 0.01%.)

It may be noted that since the thicknesses dₙ of the vertical bars 16 in the streamwise direction are all equal to each other and to the thickness D of the grid 10 in the streamwise direction in the particular examples of grids 10 shown in FIG. 1 (in each case, 10 mm in these specific examples), the aspect ratios of the vertical bars 16 in the different layers are not the same between layers given that the widths of the vertical bars 16 vary from layer 12 to layer 12. It is preferred that the aspect ratio of the vertical bars 16 within a layer 12 are the same for all vertical bars 16 across the layer 12 so as not to affect the mean velocity profile. In general though, the thicknesses dₙ of the vertical bars 16 do not all have to be equal to each other or equal to the thickness of the grid 10. They may be modified through modifications, for example as explained in the following.

Blocks of different thicknesses may be attached to the lee side of the grid to achieve this uniform aspect ratio for all layers 12, and consequent a uniform drag coefficient. The blocks may be of foam or acrylic, for example. Since the width of the vertical bars 16 in each layer 12 may be different, the resulting thicknesses of the modified vertical bars 16 may vary from layer 12 to layer 12.

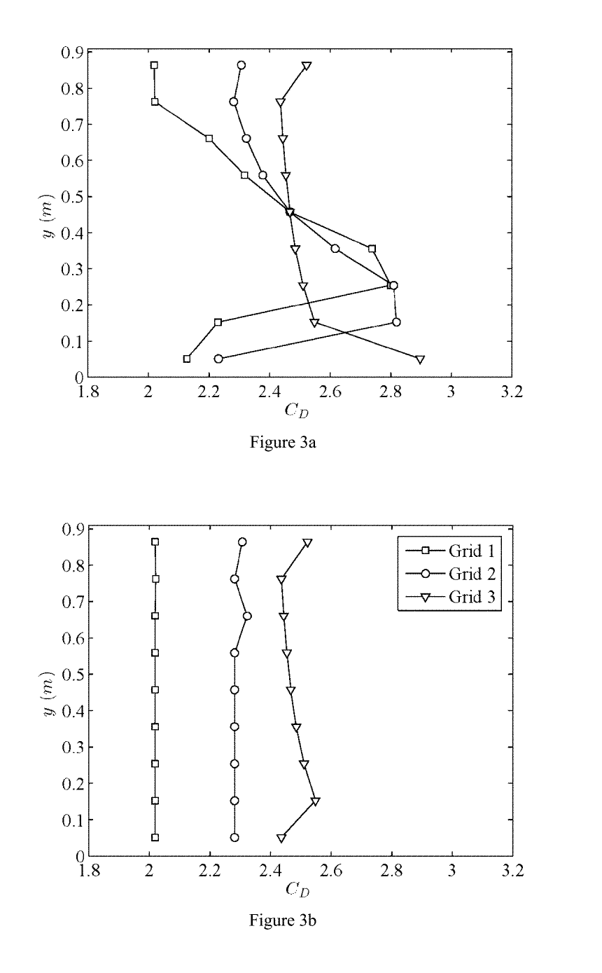

The corresponding drag coefficients C_{d} for the vertical bars 16 for these example grids 10 before and after the thickness modification are shown in FIGS. 3a and 3b, respectively. By comparing FIGS. 3a and 3b, it is apparent that the modification changes the drag coefficient of each layer 12 and can make them substantially uniform for each individual grid 10. Due to the dimensions of the vertical bars 16, the aspect ratio is set equal to that of the eighth layer. In the example of grid 3, however, the modification is only applied to the bottom layer n=1, because the additional thicknesses to be attached to the other layers are all smaller than 1 mm.

Before showing the measured vertical mean velocity profiles produced by the grids, we refer to previous works which used wire gauze to produce arbitrary flow profiles. Following the paper “The effect of wire gauze on small disturbances in a uniform stream” by Taylor, G. I., Batchelor, G. K., Dryden, H. L. & Schubauer, G. B., published Q. J. Mech. Appl. Math. 2 (1) in 1949, and the paper “Steady flow past non-uniform wire grids” by McCarthy, J. H., published J. Fluid Mech. 19 (04), in 1964, the entire content of each of which is incorporated herein by reference, the velocity field near the grid can be expressed as:

$$\frac{{u}_{+ 0}}{{u}_{- 0}} = \frac{1 + {α}_{n} - {α}_{n} {K}_{n}}{1 + {α}_{n} + {K}_{n}}$$

where u₊₀ denotes the downstream velocity, u₋₀ denotes the upstream velocity, the subscript n denotes the layer number, i.e. different height, αₙ is the refraction angle, and Kₙ is the resistance coefficient of the grid, which can be calculated from

$${K}_{n} = \frac{r {σ}_{n}}{{( 1 - {σ}_{n} )}^{2}}$$

where σₙ is the local blockage ratio of the grid, and r is an empirical constant chosen to be r=0.7 in this example. Finally, an empirical expression of the refraction angle caused by the presence of the grid is given by both Taylor and McCarthy as

αₙ=1.1(1+Kₙ)^{-1/2}.

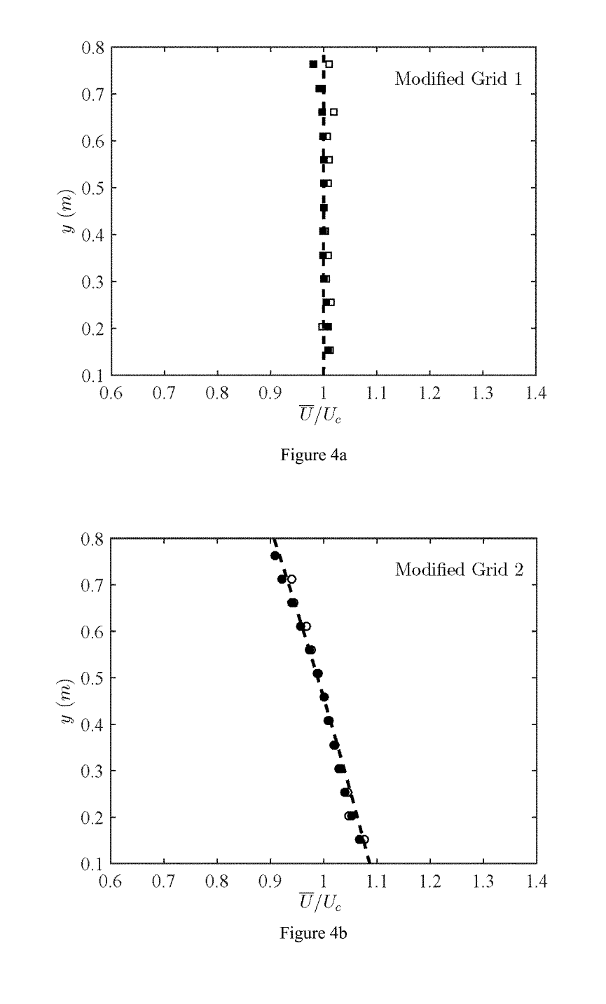

In FIGS. 4a, 4b and 4c, we present the vertical profiles measured at x=0.83 m (empty symbols) and x=4.13 m (filled symbols) for the grids 10 (i.e. with drag coefficients C_{D} as shown in FIG. 3b) shown in FIG. 1a, 1b and 1c, respectively, together with the profiles calculated using equations above with r=0.7. It can be seen that all measurements collapse well with the predicted profile (dashed lines). In previous tests in which the aspect ratios of the vertical bars 16 at each layer were not uniform, the collapse with the predicted profile was not as good, which demonstrates the effectiveness of uniformity of aspect ratios of the vertical bars 16 at each layer 12. These results are obtained without trial and error, suggesting that equations given above can serve as a predictive guideline for the bespoke design of desired mean velocity profiles for our proposed inhomogeneous multiscale geometries. The absolute value of the averaged mean shear rate |∂U/∂y| at x=0.83 m and x=4.13 m is 0.29 s⁻¹, 2.97 s⁻¹ (2.5 s⁻¹ if two end points are excluded), and 4.99 s⁻¹ for grids 1, 2, and 3, respectively. These shear rates are rather small. Nevertheless, higher shear rates could be achieved by increasing the gradient of blockage ratios σₙ of the grid (while limiting σₘₐₓ) as shown in FIG. 2. The number of vertical bars cₙ and/or their width wₙ can be used to alter the local blockage, giving some freedom for the design of turbulence intensities.

In the paper “Turbulence Without Richardson-Kolmogorov Cascade” by N. Mazellier and J. C. Vassilicos, published Physics of Fluids 22, 075101 (2010), and the paper “Particle Image Velocimetry Study of Fractal-Generated Turbulence” by R. Gomes-Fernandes, B. Ganapathisubramani and J. C. Vassilicos, published Journal of Fluid Mechanics, September 2012, pages 1 to 31, the entire content of each of which is incorporated herein by reference, there are reports and discussions of experimental results concerning wind tunnel turbulence generated by multiscale/fractal grids. Examples of such multiscale/fractal grids are disclosed in our WO2007/113335A2 and WO2009/124939A1, the entire contents of which are incorporated herein by reference.

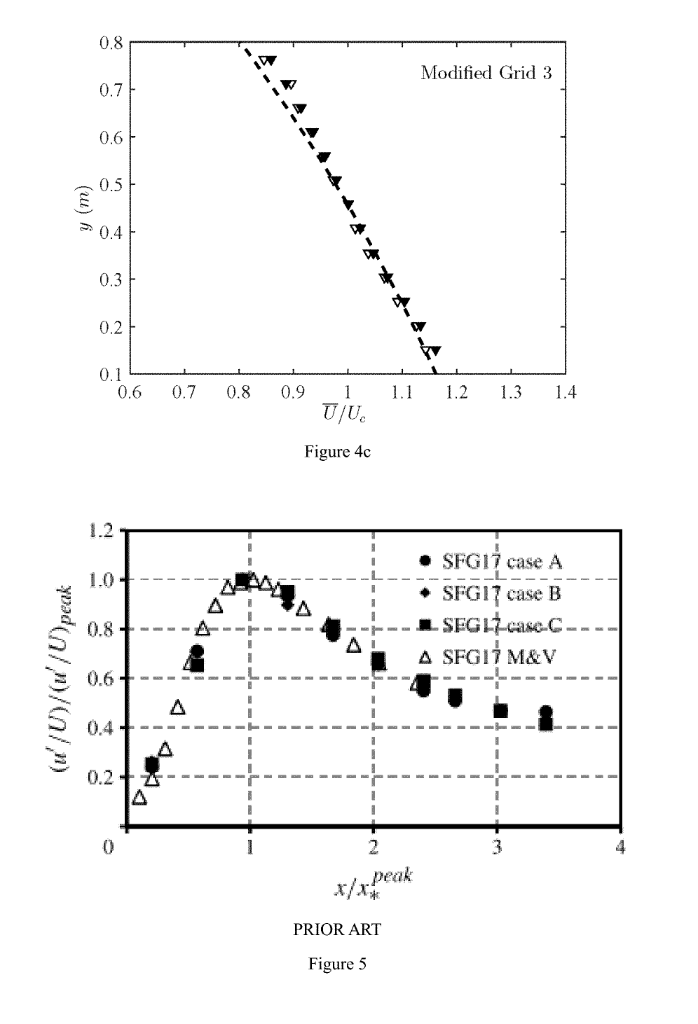

FIG. 5, which is taken from the paper “Particle Image Velocimetry Study of Fractal-Generated Turbulence” mentioned above, shows turbulence intensity profiles along the center line in relation to normalized streamwise distance behind examples of the fractal grids. It can be seen that there is a long production region (where turbulence intensity level increases) and a long decay region (where turbulence intensity level decreases). These papers introduce the wake interaction length scale peak x_{*}^{peak}, which can be calculated from the geometry of the grid and which can be used to normalize the streamwise development of the turbulence intensity profiles. In a particular example, x_{*}^{peak} can be calculated as x_{*}^{peak}=0.21gₙ²/(0.231C_{d}wₙ). From FIG. 5, it is observed that the length scale x_{*}^{peak} can be used to collapse the streamwise development of the turbulence intensity. In another paper “Particle Image Velocimetry study of fractal-generated turbulence” by Gomes-Fernandes, R., Ganapathisubramani, B. & Vassilicos, J. C. published J. Fluid Mech. 711 (2012), page 306 to 336, the entire content of which is incorporated herein by reference, the authors proposed a scaling law for such streamwise development of turbulence intensities as

u′/U_{∞}˜1/β(C_{d}wₙ/x_{*}^{peak})^{-1/2}

where α=8.3 is a constant for laminar incoming flow condition. Then it was shown that the scaled turbulence intensity (u′/U_{∞})β(C_{d}wₙ/x_{*}^{peak})^{-1/2} collapsed over several experiments. Note however, this scaling was proposed for fractal square grids, and the flow was homogeneous and isotropic. In the current case, there is a mean shear rate and the local convection velocity at each layer is different (for grid 2 and grid 3). Therefore, we include the mean streamwise velocity in the new scaling equation as

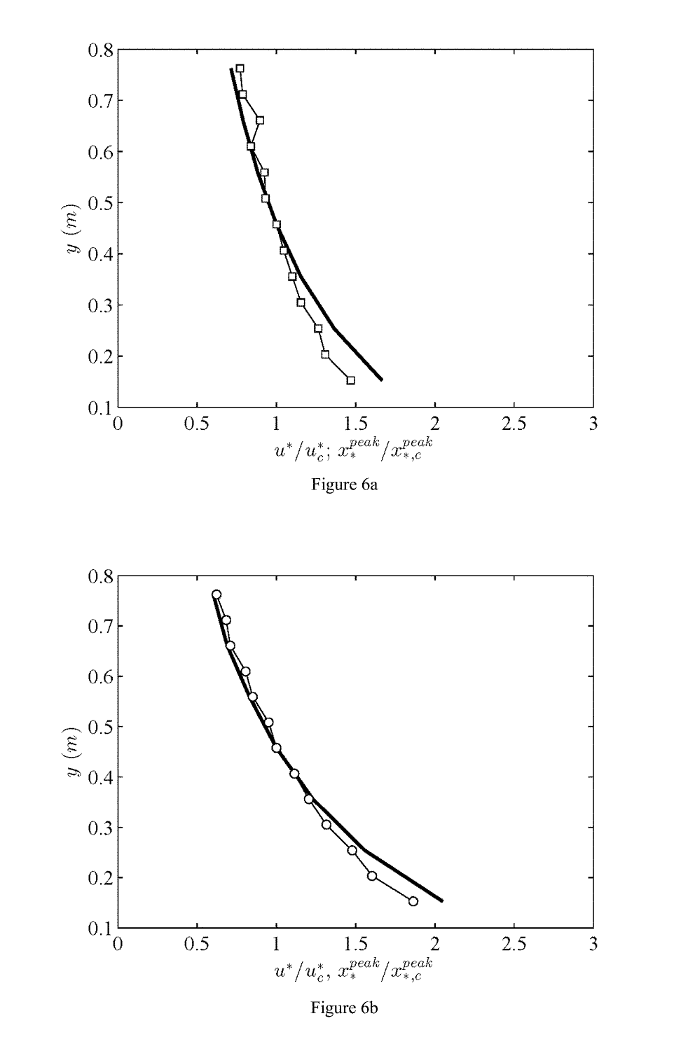

u*=(u′/U_{∞})U_{n,p}β(C_{d}wₙ/x_{*}^{peak})^{-1/2},

where U_{n,p} is the local mean velocity calculated from the mean velocity equations. With this method of scaling u*, it is possible at least to prescribe the shape of the turbulence intensity profile by calculating x_{*}^{peak} from the geometries of the grid and the desired mean velocity profile U_{n,p}. The results are shown in FIGS. 6a, 6b, and 6c for grids 10 shown in 1a, 1b and 1c, respectively. FIGS. 6a to 6c show the scaling of the normalized turbulence intensity u*/u_{c}* where u*=(u′/U_{∞})U_{n,p}β(C_{d}wₙ/x_{*}^{peak})^{-1/2}, u′ the measurement along the y direction at x=0.83 m, and U_{n,p} is the predicted mean velocity profile for grid 1 (a), grid 2 (b), grid 3 (c), respectively. Solid lines are normalized scaling parameter x_{*}^{peak}/x_{*,c}^{peak} where the subscript c denotes the centerline value measured at y=0.46 m.

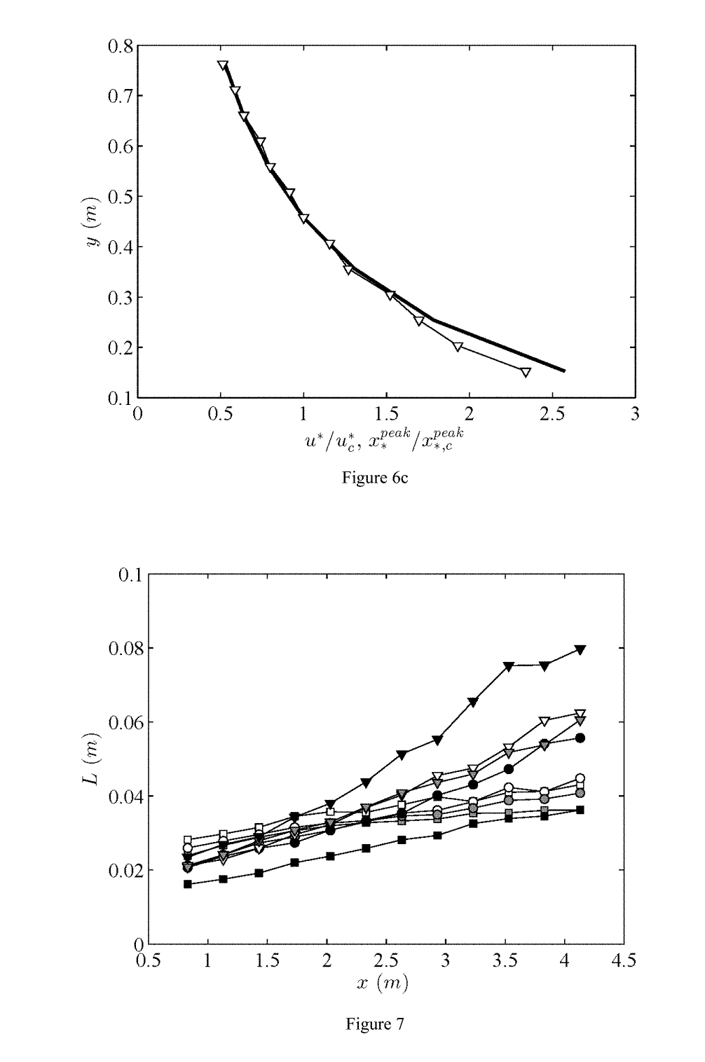

The longitudinal integral length scale L as a function of the streamwise direction for all grids is presented in FIG. 7 for grid 1 (square), grid 2 (circle) and grid 3 (triangle) at y=0.25 m (white), y=0.46 m (grey) and y=0.66 m (black) versus. The “length scale” corresponds to eddy sizes in the turbulent flow and the “integral length scale” corresponds to the size of the largest eddies. It is apparent that L increases with the streamwise location monotonically, which is consistent with previous results. The profile with largest slope (black triangle) is near the top of grid 3. This is the location where x_{*}^{peak} is the smallest and therefore the local turbulence has the longest time to develop, leading to a larger L. In practice, the gap gₙ between two adjacent vertical bars 16 within a layer 12 can be increased to maximize the integral length scale in the generated turbulent flow.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A turbulence-generating grid for producing a turbulent flow, the grid having a top and a bottom and opposed sides and comprising a number N of layers, each layer being defined between respective pairs of horizontal bars and the sides of the grid, each layer being subdivided by a number cₙ of vertical bars so as to define a plurality of respective through holes between at least adjacent pairs of the vertical bars and the horizontal bars, wherein at least one of the dimensions and the spacings of the vertical bars of one of the layers is different from the at least one of the dimensions and the spacings of the vertical bars of another of the layers.

2. A turbulence-generating grid according to claim 1, wherein the aspect ratio of each of the vertical bars across a layer are the same.

3. A turbulence-generating grid according to claim 1, wherein each layer has a respective blockage ratio σₙ, and the blockage ratio σₙ for at least some of the layers are different from each other.

4. A turbulence-generating grid according to claim 3, wherein the difference of the blockage ratio between two adjacent layers is the same for all pairs of adjacent layers of the grid.

5. A turbulence-generating grid according to claim 1, wherein the dimensions and the spacings of the vertical bars of one of the layers are different from the dimensions and the spacings of the vertical bars of another of the layers.

6. A turbulence-generating grid according to claim 1, wherein at least one of the dimensions and the spacings of the vertical bars of each of the layers differ from layer to layer.

7. A turbulence-generating grid according to claim 1, wherein at least one of the dimensions and the spacings of the vertical bars of the layers changes monotonically from layer to layer.

8. A method of manufacturing a turbulence-generating grid which in use produces a turbulent flow having a mean velocity profile and a turbulence intensity profile, the grid having a top and a bottom and opposed sides and comprising a number N of layers, wherein n is the layer number for the respective layers, each layer being defined between respective pairs of horizontal bars and the sides of the grid, each layer being subdivided by a number cₙ of vertical bars so as to define a plurality of respective through holes between at least adjacent pairs of the vertical bars and the horizontal bars, each layer having a respective blockage ratio σₙ, the method comprising:
selecting the number N of layers;
calculating the height hₙ of each of the layers;
calculating a blockage ratio σₙ of each of the layers to achieve the desired mean velocity profile;
calculating the number cₙ of vertical bars and the dimensions and spacings of the vertical bars for each of the layers to achieve the calculated blockage ratio σₙ of each of the layers and the desired turbulence intensity profile of the grid; and
manufacturing the turbulence-generating grid having the selected number N of layers, calculated height hₙ of each of the layers, and calculated number cₙ of vertical bars and calculated dimensions and spacings of the vertical bars for each of the layers.

9. A method according to claim 8, wherein the aspect ratio of the vertical bars within at least one of the layers are the same for all vertical bars across said layer.

10. A method according to claim 8, wherein the number cₙ of vertical bars and the dimensions and spacings of the vertical bars for each of the layers is calculated so as to maintain constant the aspect ratio of each of the vertical bars across a layer.

11. A method according to claim 8, comprising attaching blocks of varying thicknesses to the grid in order to maintain the constant aspect ratio of each of the vertical bars across a layer.

12. A method according to claim 8, wherein, for each of the layers, the width wₙ of the vertical bars of the layer is calculated according to:
$${w}_{n} = \{ \begin{matrix}( ( W * {h}_{n} * {σ}_{n} - W * t ) / ( {h}_{n} - t ) ) / {c}_{n} & n = 2 , 3 , … N - 1 \\ ( ( W * {h}_{n} * {σ}_{n} - W * 0.5 t ) / ( {h}_{n} - 0.5 t ) ) / {c}_{n} & n = 1 , N\end{matrix} .$$
wherein:
W is the overall width of the grid
hₙ is the height of the layer
σₙ is the blockage ratio of the layer
t is the width of the horizontal bars of the layer
cₙ is the number of vertical bars of the layer.

13. A method according to claim 8, wherein the difference of the blockage ratio between two adjacent layers is the same for all pairs of adjacent layers of the grid.

14. A method according to claim 8, wherein the dimensions and the spacings of the vertical bars of one of the layers are different from the dimensions and the spacings of the vertical bars of another of the layers.

15. A method according to claim 8, wherein at least one of the dimensions and the spacings of the vertical bars of each of the layers differ from layer to layer.

16. A method according to claim 8, wherein at least one of the dimensions and the spacings of the vertical bars of the layers changes monotonically from layer to layer.

17. A turbulence-generating grid manufactured in accordance with a method according to claim 8.

18. A computer-implemented method of designing a turbulence-generating grid which in use produces a turbulent flow having a mean velocity profile and a turbulence intensity profile, the grid having a top and a bottom and opposed sides and comprising a number N of layers, wherein n is the layer number for the respective layers, each layer being defined between respective pairs of horizontal bars and the sides of the grid, each layer being subdivided by a number cₙ of vertical bars so as to define a plurality of respective through holes between at least adjacent pairs of the vertical bars and the horizontal bars, each layer having a respective blockage ratio σₙ, the method comprising:
selecting the number N of layers;
calculating the height hₙ of each of the layers;
calculating a blockage ratio σₙ of each of the layers to achieve the desired mean velocity profile; and
calculating the number cₙ of vertical bars and the dimensions and spacings of the vertical bars for each of the layers to achieve the calculated blockage ratio σₙ of each of the layers and the desired turbulence intensity profile of the grid.
